(19) United States
(12) Patent Application Publication
(10) Pub. No.: US 2020/0059170 A1
(43) Pub. Date: Feb. 20, 2020

(54) SYSTEM AND METHOD FOR DETERRING THEFT

(71) Applicant: BLACK & DECKER INC., New Britain, CT (US)

(72) Inventors: Daniele C. Brotto, Baltimore, MD (US); Nathan J. Cruise, Phoenix, MD (US); Jeremy D. Ashinghurst, Baltimore, MD (US); Jason K. Leh, Shrewsbury, PA (US)

(21) Appl. No.: 16/524,574

(22) Filed: Jul. 29, 2019

Related U.S. Application Data
(60) Provisional application No. 62/718,684, filed on Aug. 14, 2018.

(51) Int. Cl. H02P 1/02; G06K 19/07; G08B 15/00

(52) U.S. Cl. CPC H02P 1/022; G08B 15/00; G06K 19/0723

(57) ABSTRACT

A theft deterring system includes a power tool with a motor connectable to a power source, a switch connected to the motor, a controller controlling to the switch for controlling an amount of power provided to the motor, and a state circuit having a memory for storing a state value. The controller activates the switch to provide power to the motor when the state value stored in the memory equals a desired value. The system may also include a tag programmer for changing the stored value.

### CROSS-REFERENCE TO RELATED APPLICATION

The present application derives priority from U.S. Patent Application No. 62/718,684, entitled “SYSTEM AND METHOD FOR DETERRING THEFT” and filed on Aug. 14, 2018, which is currently pending, and wholly incorporated by reference.

### FIELD

The present invention relates to a system and method for deterring theft, and more particularly to a system and method for deterring theft of items in a retail environment.

### BACKGROUND

Theft of inventory at brick-and-mortar stores is a problem resulting in lost revenue and incorrect inventory reporting. Prior art solutions include putting the highly-stolen products under lock does not completely eliminate the problem as the theft can occur after the display lock has been unlocked. Theft deterrent systems such as antitheft lanyards and locks adversely burden the checkout processes, are costly, need to be maintained and interfere with the buying experience.

It is an object of the invention to provide an improved system and method for deterring theft of items in a retail environment. Preferably such system and method will provide a simple checkout procedure to validate the purchase.

### DESCRIPTION OF THE DRAWINGS

Preferred embodiments of the invention will now be described, by way of example, with reference to the accompanying drawings, of which:

FIG. 1 is a perspective view of an embodiment of the theft deterring system;

FIG. 2 is a block diagram of a first embodiment of a power tool that is part of the theft deterring system;

FIG. 3 is a block diagram of a second embodiment of a power tool that is part of the theft deterring system; and

FIG. 4 is a block diagram of an embodiment of a power tool battery pack that is part of the theft deterring system.

### DETAILED DESCRIPTION

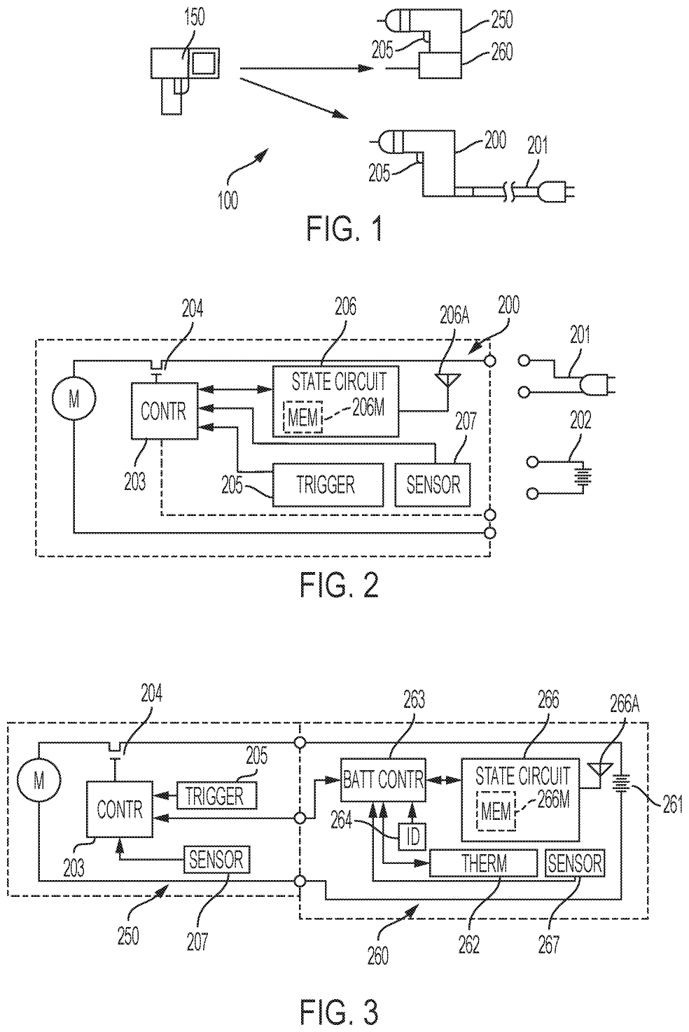

FIG. 1 shows a perspective view of a theft deterring system 100, which preferably includes a power tool 200 and/or 250, and a tag programmer 150. Referring to FIG. 2, power tool 200 may have a motor M connected to a power source, such as AC power via power cord 201, or battery pack 202. A controller 203 may control a switch or FET 204 for controlling the amount of power provided to motor M. Controller 203 may use inputs from the trigger 205 and other sensors 207 to vary the amount of power provided to motor M.

Controller 203 may also receive input from a state circuit 206. State circuit 206 may have a memory 206M which stores a state value. State circuit 206 may have an antenna 206A which receives a signal from tag programmer 150. Persons skilled in the art may recognize that state circuit 206 may be a passive RFID tag circuit with rewrittable memory (which can be powered by the signal transmitted by tag programmer 150), or an active RFID tag with rewrittable memory (which can be powered by the AC power source, battery pack 202 or a separate battery (not shown).

With such arrangement, the memory 206M can be set to have a value representative of a first state. For example, such value may be “0” which could represent an unactivated state. Such value can be set at manufacture or during shipping from the factory.

A person may take such power tool 200 from a store display to a register for payment. At that time, a store employee can use tag programmer 150 to change the value set in memory 206M. For example, such value can be changed to “1” which could represent an activated state. When the person then tries to use the power tool 200, controller 203 would query state circuit 206 (and/or memory 206M) when trigger 205 is activated. Once controller 203 sees the value representing the activated state, it can provide power to the motor M.

If a person were to steal power tool 200 without it being properly processed at check out, the value set in memory 206M would not be changed. As before, when the person then tries to use the power tool 200, controller 203 would query state circuit 206 (and/or memory 206M) when trigger 205 is activated. Because controller 203 would not see the value representing the activated state (or instead see a value representing the unactivated state), controller 203 would not provide any power to the motor M, or instead it could provide power to motor M at a lower amount than if the memory 206M had the value representing the activated state.

Persons skilled in the art shall recognize that the system 100 can have more than two states. For example, memory 206M could be programmed to have different values representing unactivated, partly activated and fully activated states. In the unactivated state, power tool 200 may not turn on, may only work at a lower setting than when fully activated, and/or may only have some features (such a motor soft start) working, if any. In the partly activated state, power tool 200 may only work at a lower setting than when fully activated and/or may work at the same setting as a fully activated power tool but only have some features (such a motor soft start) working, if any. In the fully activated state, power tool 200 may work at the full settings and/or have all features (such a motor soft start) working.

Referring to FIG. 3, power tool 250 may have similar features to power tool 200, and like numerals refer to like parts. Power tool 250 may have a motor M connected to a battery pack 260. A controller 203 may control a switch or FET 204 for controlling the amount of power provided to motor M. Controller 203 may use inputs from the trigger 205 and other sensors 207 to vary the amount of power provided to motor M.

Battery pack 260 may have at least one cell 261, which is preferably rechargeable. In addition, battery pack 260 may have a battery control circuit 263 which receives inputs from different sensors 267, thermistor 262, ID resistor 264 and/or controller 203 to provide data and/or instructions to controller 203. Such data and/or instructions can be provided by battery control circuit 263 to controller 203 upon request of controller 203, or automatically. Such data can be used by controller 203 to determine the amount of power provided to motor M. Alternatively or additionally, battery control circuit 263 can provide instructions to controller 203 on the amount of power provided to motor M.

Battery control circuit 263 may also receive input from a state circuit 266. State circuit 266 may have a memory 266M which stores a state value. State circuit 266 may have an antenna 266A which receives a signal from tag programmer 150. Persons skilled in the art may recognize that state circuit 266 may be a passive RFID tag circuit with rewrittable memory (which can be powered by the signal transmitted by tag programmer 150), or an active RFID tag with rewrittable memory (which can be powered by the cell(s) 261 or a separate battery cell (not shown)).

With such arrangement, the memory 266M can be set to have a value representative of a first state. For example, such value may be “0” which could represent an unactivated state. Such value can be set at manufacture or during shipping from the factory.

A person may take such power tool 250 or battery pack 260 from a store display to a register for payment. At that time, a store employee can use tag programmer 150 to change the value set in memory 266M. For example, such value can be changed to “1” which could represent an activated state. When the person then tries to use the power tool 250, controller 203 would query battery control circuit 263, state circuit 266 and/or memory 266M when trigger 205 is activated. Once controller 203 sees the value representing the activated state, it can provide power to the motor M.

If a person were to steal power tool 250 or battery pack 260 without it being properly processed at check out, the value set in memory 266M would not be changed. As before, when the person then tries to use the power tool 250, controller 203 would query battery control circuit 263, state circuit 266 and/or memory 266M when trigger 205 is activated. Because controller 203 would not see the value representing the activated state (or instead see a value representing the unactivated state), controller 203 would not provide any power to the motor M, or instead it could provide power to motor M at a lower amount than if the memory 266M had the value representing the activated state.

Persons skilled in the art shall recognize that the system 100 can have more than two states. For example, memory 266M could be programmed to have different values representing unactivated, partly activated and fully activated states. In the unactivated state, power tool 250 may not turn on, may only work at a lower setting than when fully activated, and/or may only have some features (such a motor soft start) working, if any. In the partly activated state, power tool 250 may only work at a lower setting than when fully activated and/or may work at the same setting as a fully activated power tool but only have some features (such a motor soft start) working, if any. In the fully activated state, power tool 250 may work at the full settings and/or have all features (such a motor soft start) working.

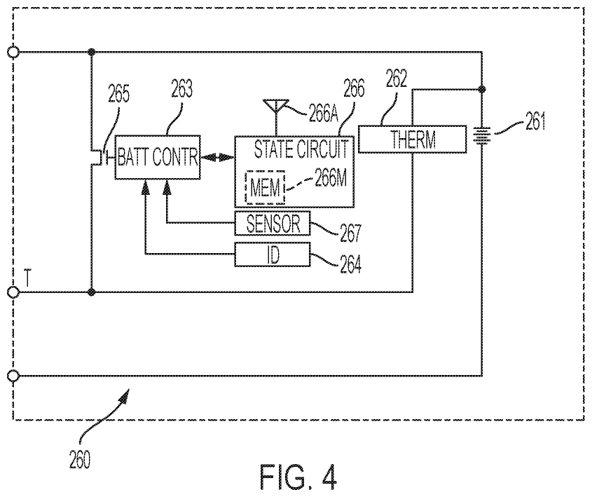

An alternative battery pack 260 is shown in FIG. 4, where like numerals refer to like parts. In this embodiment, controller 203 can receive temperature data from thermistor 262, so if the temperature of battery pack 260 goes above a certain threshold, it can stop providing power to motor M. Battery control circuit 263 does not provide instructions to controller 203 upon request of controller 203.

Instead, battery control circuit 263 controls a switch or FET 265. If battery control circuit 263 turns on FET 265, the voltage of the terminal T is raised. Controller 203 could interpret such voltage to be a high temperature signal from thermistor 262, and stop providing power to motor M.

Battery control circuit 263 can receive inputs from different sensors 267 and/or ID resistor 264. Like before, battery control circuit 263 may also receive input from state circuit 266. When the person then tries to use the power tool 250, battery control circuit 263 would sense the current draw. In view of such current draw, battery control circuit 263 would query state circuit 266 and/or memory 266M. Once battery control circuit 263 sees the value representing the activated state, it would not activate FET 265, allowing controller 203 to provide power to the motor M.

If a person were to steal power tool 250 or battery pack 260 without it being properly processed at check out, the value set in memory 266M would not be changed. As before, battery control circuit 263 would sense the current draw. In view of such current draw, battery control circuit 263 would query state circuit 266 and/or memory 266M. Once battery control circuit 263 sees the value representing the unactivated state, it would activate FET 265, which would urge controller 203 to not provide power to the motor M.

Persons skilled in the art shall recognize that memories 206M, 266M may also be reprogrammed via a non-wireless method. For example, power tools 200, 250 and/or battery packs 260 may have a USB port which allows someone at check out to plug in a device 150 that would reprogram memories 206M, 266M to have the value representative of the activated states. Alternatively such device 150 can be plugged into the terminals of power tool 250, power cord 201 and/or battery pack 260.

It will be understood that the above description and the drawings are examples of particular implementations of the invention, but that other implementations of the invention are included in the scope of the claims.

What is claimed is:

1. A theft deterring system comprising:
a power tool comprising:
a motor connectable to a power source,
a switch connected to the motor,
a controller connected to the switch, the controller controlling the switch for controlling an amount of power provided to the motor,
a state circuit having a memory for storing a state value,
wherein the controller activates the switch to provide power to the motor when the state value stored in the memory equals a desired value.

2. The theft deterring system of claim 1, wherein the state circuit is connected to the controller.

3. The theft deterring system of claim 2, wherein the state circuit is at least one of a passive RFID tag circuit with rewrittable memory and an active RFID tag with rewrittable memory.

4. The theft deterring system of claim 1, wherein the power source is a battery pack connectable to the motor.

5. The theft deterring system of claim 4, wherein the battery pack comprises a battery control circuit that can provide data and/or instructions to the controller.

6. The theft deterring system of claim 4, wherein the state circuit is connected to the battery control circuit.

7. The theft deterring system of claim 4, wherein the switch is disposed within the battery pack.

8. The theft deterring system of claim 1, further comprising a tag programmer for changing the stored value.

9. The theft deterring system of claim 8, wherein the state circuit further comprises an antenna.

10. The theft deterring system of claim 9, wherein the antenna receives a signal from the tag programmer.
